(19) United States
(12) Patent Application Publication
(10) Pub. No.: US 2026/0064443 A1
(43) Pub. Date: Mar. 5, 2026

(54) ARTIFICIALLY INTELLIGENTLY MODELING USER ACTIVITY

(71) Applicant: Oracle International Corporation, Redwood Shores, CA (US)

(72) Inventors: Raghuveer Surisetty, Edison, NJ (US); Arun Ramamurthy, Danbury, CT (US); Jing Xue, Burlington, MA (US); Geordan Drummond, Allentown, PA (US)

(73) Assignee: Oracle International Corporation, Redwood Shores, CA (US)

(21) Appl. No.: 19/094,692

(22) Filed: Mar. 28, 2025

Related U.S. Application Data
(60) Provisional application No. 63/689,523, filed on Aug. 30, 2024.

(51) Int. Cl. G06F 9/451; G06N 3/08

(52) U.S. Cl. CPC G06F 9/451; G06N 3/08

(57) ABSTRACT

Systems, methods, and computer-readable media are provided for training and using a multi-layer neural network to detect a set of most likely action tuples each comprising a next user interface, a next operation, and a next data slice at least in part by training the multi-layer neural network to predict sequentially next user input and sequentially previous user input for adjacent groups. An example method may include providing a particular data structure as input to the multi-layer neural network to predict a particular action tuple comprising a next particular operation, a next particular user interface, and a next particular data slice to be used by a particular user as the particular user navigates a particular user interface. The method may also include causing display of a summary of the particular action tuple and an option to perform a particular user interface navigation to a particular user navigation target.

### CROSS REFERENCE TO RELATED APPLICATIONS

This application claims the benefit of U.S. Provisional Patent Application No. 63/689,523, filed on Aug. 30, 2024, the entire disclosure of which is incorporated by reference herein in its entirety for all purposes.

### BACKGROUND

The financial closing process is an aspect of accounting that supports providing accurate and complete financial records. However, there is a significant tradeoff between the level of detail involved in this process and the time required to complete it. A more detailed and thorough closing process can lead to higher accuracy and reliability in financial reporting, but it also demands more time and resources, which can impact a company's operational efficiency.

A detailed financial closing process minimizes the risk of errors and discrepancies in the financial statements. By carefully reconciling accounts, adjusting entries, and reviewing financial statements, companies can ensure that their financial data reflects the true financial position and performance. This level of detail improves decision-making, as management, investors, and other stakeholders rely on accurate information to make informed choices. Moreover, for publicly traded companies, thoroughness in financial reporting is necessary to comply with regulatory requirements and avoid legal or financial penalties.

However, the more detailed the financial closing process, the longer it takes to complete. This extended time frame can delay the availability of financial reports, which in turn can slow down decision-making processes. In fast-paced industries, where timely information is crucial for maintaining competitive advantage, a lengthy closing process may hinder the company's ability to respond quickly to market changes. Additionally, a more time-consuming process can tie up accounting and finance resources, leaving less capacity for other critical tasks such as budgeting, forecasting, and financial analysis.

Moreover, the time invested in a detailed closing process can lead to increased labor costs and potential fatigue among accounting staff. Companies may need to hire additional personnel or invest in overtime pay to meet reporting deadlines, which can strain the organization's budget. This resource allocation must be carefully managed, as overextending resources in the closing process can impact the overall efficiency and productivity of the finance department.

Ultimately, the tradeoff between the efficiency of the financial closing process and the time it takes to complete is a balancing act that companies try to manage. While a detailed process ensures accuracy and compliance, it can also delay critical decision-making and strain resources.

### BRIEF SUMMARY

In some embodiments, a computer-implemented method includes training and using a multi-layer neural network to detect a set of learned action tuples each comprising a next user interface, a next operation, and a next data slice at least in part by training the multi-layer neural network to predict sequentially next user input and sequentially previous user input for adjacent groups. The method may also include providing a particular data structure as input to the multi-layer neural network to predict a particular action tuple comprising a next particular operation, a next particular user interface, and a next particular data slice to be used by a particular user as the particular user navigates a particular user interface. The method may also include causing display of a summary of the particular action tuple and an option to perform a particular user interface navigation to a particular user navigation target.

In a particular embodiment, a computer-implemented method comprises training a multi-layer neural network to detect a set of learned action tuples each comprising a next user interface, a next operation, and a next data slice. The multi-layer neural network is trained at least in part by randomly selecting adjacent groups of user inputs to predict a sequentially next user input. The multi-layer neural network is also trained at least in part by randomly selecting adjacent groups of user inputs to predict a sequentially previous user input. The multi-layer neural network is trained on one or more vector embeddings comprising a data slice in use, an interface in use, and an operation being performed at adjacent times. The computer-implemented method further comprises receiving particular input from a particular user as the particular user navigates to a particular user interface to perform one or more tasks against multidimensional data. The computer-implemented method further comprises detecting that the particular input causes a particular operation to be performed on the particular user interface with respect to a particular data slice. The computer-implemented method further comprises storing a particular data structure that identifies the particular operation, the particular user interface, and the particular data slice. The computer-implemented method further comprises providing the particular data structure as input to the multi-layer neural network to predict a particular set of particular action tuples, each comprising a next particular operation, a next particular user interface, and a next particular data slice to be used by the particular user as the particular user navigates the particular user interface. The computer-implemented method further comprises determining, for a particular action tuple of the particular set of particular action tuples, a particular user interface navigation target for the next particular operation, the next particular user interface, and the next particular data slice. The particular user interface navigation target causes user interface navigation based on the next particular operation, the next particular user interface, or the next particular data slice, or a combination thereof. The computer-implemented method further comprises causing display of a particular summary of the particular action tuple and an option to perform the particular user interface navigation to the particular user interface navigation target.

In a further embodiment, the computer-implemented method further comprises executing, for a selected particular action tuple, the option by causing the particular user interface navigation to the particular user interface target.

In the same or a different further embodiment, the computer-implemented method further comprises causing display of the option as a selectable link in the particular user interface, where the executing the option is in response to user input selecting the selectable link.

In another embodiment that extends the particular embodiment or any further embodiment, the computer-implemented method further comprises storing data collected during one or more user sessions of the particular user. The stored data indicates previously selected and executed options corresponding to previously predicted particular action tuples associated with the particular user. The computer-implemented method further comprises training a machine learning model to select a set of most likely action tuples from the particular set of particular action tuples based at least in part on the stored data. The computer-implemented method further comprises using the trained machine learning model to select a subset of the particular set of particular action tuples as the set of most likely action tuples. The determining the particular user interface navigation target, the causing display of the particular summary, and the causing display of the option may be for each most likely action tuple of the set of most likely action tuples.

In another embodiment that extends the particular embodiment or any further embodiment, the computer-implemented method further comprises selecting, as a set of most likely action tuples, a subset of the particular set of particular action tuples. The determining the particular user interface navigation target, the causing display of the particular summary, and the causing display of the option may be for each most likely action tuple of the set of most likely action tuples.

In another embodiment that extends the particular embodiment or any further embodiment, the selecting the set of most likely action tuples is based at least in part on respective likelihoods of each particular action tuple of the particular set of particular action tuples, the respective likelihoods being predicted using the multi-layer neural network.

In another embodiment that extends the particular embodiment or any further embodiment, the selecting the set of most likely action tuples from the particular set of particular action tuples is based at least in part on previously selected and executed options corresponding to previously predicted particular action tuples associated with the particular user.

In another embodiment that extends the particular embodiment or any further embodiment, the selecting the set of most likely action tuples comprises selecting a threshold quantity of action tuples from the particular set of particular action tuples as the set of most likely action tuples.

In another embodiment that extends the particular embodiment or any further embodiment, the computer-implemented method further comprises storing data collected during one or more user sessions of the particular user, the stored data indicating previously selected and executed options corresponding to previously predicted particular action tuples associated with the particular user. The computer-implemented method further comprises training a machine learning model to determine the threshold quantity of action tuples based at least in part on the stored data. The computer-implemented method further comprises using the trained machine learning model to adjust the threshold quantity of action tuples that is to be selected from the particular set of particular action tuples as the set of most likely action tuples.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for training and using a multi-layer neural network to detect a set of learned action tuples each comprising a next user interface, a next operation, and a next data slice at least in part by training the multi-layer neural network to predict sequentially next user input and sequentially previous user input for adjacent groups.

FIG. 2 illustrates a system diagram showing an example system for training and using a multi-layer neural network to detect a set of learned action tuples each comprising a next user interface, a next operation, and a next data slice at least in part by training the multi-layer neural network to predict sequentially next user input and sequentially previous user input for adjacent groups.

FIG. 3 illustrates a flow chart of an example process for training and using a multi-layer neural network to detect a set of learned action tuples each comprising a next user interface, a next operation, and a next data slice at least in part by training the multi-layer neural network to predict sequentially next user input and sequentially previous user input for adjacent groups.

FIG. 4A shows example actions a user may follow as part of the system.

FIG. 4B shows additional example actions a user may follow as part of the system.

FIG. 5A illustrates an example process for a cloud implementation for training and using a multi-layer neural network to detect a set of learned action tuples.

FIG. 5B illustrates another example process for a cloud implementation for training and using a multi-layer neural network to detect a set of learned action tuples.

FIG. 6 shows an example main screen of a graphical user interface into which some embodiments of the system may be integrated.

FIG. 7 shows an example module relating to foreign exchange rates which may be present in some embodiments of the described system.

FIG. 8 shows an example configuration screen where a user may adjust parameters of the proposed system in some embodiments.

FIG. 9A is an example table that demonstrates an example of how data for the machine learning model may be stored in some embodiments of the described system.

FIG. 9B depicts additional rows of the example table of FIG. 9A.

FIG. 10A shows an example of how the recommendations of the machine learning model may be presented to the user via the graphical user interface in some embodiments.

FIG. 10B shows another user interface displayed based on the user accepting the recommendation via the graphical user interface of FIG. 10A.

FIG. 11 depicts a simplified diagram of a distributed system for implementing certain aspects.

FIG. 12 is a simplified block diagram of one or more components of a system environment by which services provided by one or more components of an embodiment system may be offered as cloud services, in accordance with certain aspects.

FIG. 13 illustrates an example computer system that may be used to implement certain aspects.

### DETAILED DESCRIPTION

A description is provided in the following sections for training and using a multi-layer neural network to detect a set of most likely action tuples each comprising a next user interface, a next operation, and a next data slice at least in part by training the multi-layer neural network to predict sequentially next user input and sequentially previous user input for adjacent groups.
APPLICATION COMPONENTS
MACHINE LEARNING (ML) MODELS
GRAPHICAL USER INTERFACE
EXAMPLE DATA ENTRY AND ORGANIZATION
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

In some embodiments, techniques incorporate graphical user interfaces (GUIs) and/or machine learning to facilitate efficiently and accurately completing a consolidation process, a closing process, and/or other data processing operations. The closing process may be configured to ensure that data from different sources accord and/or reconcile with each other, which may support generation of a cumulative product that is balanced. For example, embodiments may pertain to a GUI and/or machine-learning model that facilitates completion of a financial closing report. Such completion may (for example) facilitate predicting input that defines a field included in or used to complete a financial closing report, such as an input that indicates a: (1) year-end inventory count and reconciliation, (2) budgeting and forecasting cycle, (3) annual performance reviews, (4) tax filing and compliance, and/or (5) quality assurance in manufacturing. In one embodiment, the GUI and/or machine learning model may additionally or alternatively facilitate predicting a next action in a series of actions associated with the closing process.

A financial closing process can include a series of steps undertaken at the end of an accounting period to ensure all financial transactions are accurately recorded and the financial statements reflect the true financial position of the company. The financial closing process may also be referred to as the closing process or financial consolidation and closing (FCC). The financial closing process can involve reconciling accounts, making necessary adjustments, reviewing and finalizing financial statements, closing temporary accounts, and preparing reports for stakeholders.

Embodiments disclosed herein can facilitate providing accurate and reliable financial information. This can support informed decision-making, regulatory compliance, and overall financial management.

The closing process may be labor or resource intensive, and may involve activities including (for example) changing metadata, loading rates, changing ownership of files or accounts, loading data, data entry, running multiple consolidations, adjustments, approvals, rerunning consolidations, running multiple reports, and/or locking data. Managing the intensive closing process is a technical problem, given that data from different sources is often inconsistent and there is no consistent solution to reconcile the inconsistencies. In some embodiments, disclosed techniques solve this technical problem by combining a graphical user interface with machine learning to predict a user's subsequent data entry and to identify potential errors. Some embodiments of the invention generate instance-specific suggestions about the next actions in the closing process. Such recommendations may be generated using a machine-learning model and/or action history of the user and/or corresponding client. The recommendations may also detect missing input and/or remind a user of the same. Thus, embodiments disclosed herein may expediate and improve the accuracy of an overall closing process.

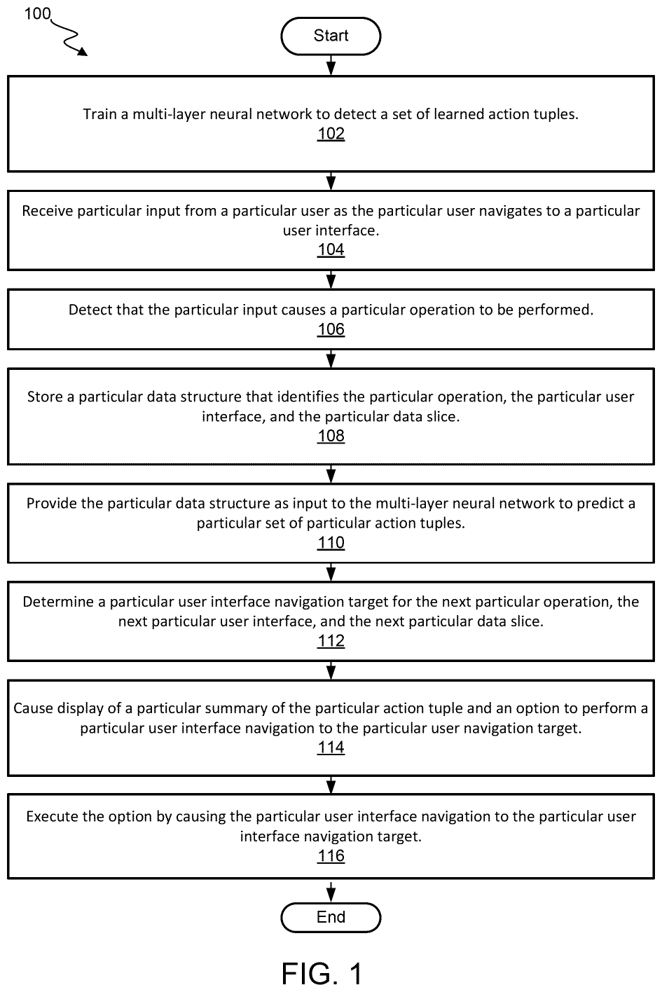

FIG. 1 shows a flow chart illustrating an example process 100 for training and using a multi-layer neural network to detect a set of learned action tuples each comprising a next user interface, a next operation, and a next data slice at least in part by training the multi-layer neural network to predict sequentially next user input and sequentially previous user input for adjacent groups.

Process 100 begins in block 102, where an example system trains a multi-layer neural network to detect a set of learned (e.g., most likely) action tuples. An action tuple may comprise one or more related and/or adjacent actions, such as a next user interface, a next operation, and/or a next data slice. In an example, the system may train, at least in part, the multi-layer neural network by selecting (e.g., randomly) adjacent groups of user inputs to predict a sequentially next user input and/or a sequentially previous user input. In an example, the system may train the multi-layer neural network on one or more vector embeddings comprising (e.g. representing) a data slice in use, an interface in use, and/or an operation being performed at adjacent times or in sequentially adjacent actions.

In block 104, the example system receives a particular input from a particular user as the particular user navigates to a particular user interface to perform one or more tasks against multidimensional data. For example, the particular input may involve the user navigating to the particular user interface, entering data, selecting a data slice, loading data from a database, etc.

Then, in block 106, the example system detects that the particular input causes a particular operation to be performed on the particular user interface with respect to a particular data slice. For example, the particular operation may include an action associated with data processing workflow, such as selecting or updating a data field or metadata in association with a particular data slice, running a report, etc. For instance, the user may select a currency exchange rate to be applied for a certain accounting period and/or with respect to data associated with two particular entities.

In block 108, the example system stores a particular data structure that identifies the particular operation, the particular user interface, and the particular data slice. For example, the particular data structure may include one or more parameters that define the particular data slice, one or more parameters indicating the particular user interface, and/or any other one or more parameters associated with the particular operation (e.g., timestamp, etc.).

In block 110, the example system provides the particular data structure as input to the multi-layer neural network to predict a particular set of (e.g., most likely) particular action tuples. Each particular action tuple may include, for example, a next particular operation, a next particular user interface, and/or a next particular data slice to be used by the particular user as the particular user navigates the particular user interface.

In block 112, the example system determines a particular user interface navigation target for the next particular operation, the next particular user interface, and/or the next particular data slice. In some examples, the particular user interface navigation target causes user interface navigation based on the next particular operation, the next particular user interface, the next particular data slice, or a combination thereof.

In some examples, the process 100 includes storing data collected during one or more user sessions of the particular user. The stored data may indicate previously selected and executed options corresponding to previously predicted particular action tuples associated with the particular user. The process 100 may also include training a machine learning model to select a set of most likely action tuples from the particular set of particular action tuples based at least in part on the stored data, and using the trained machine learning model to select a subset of the particular set of particular action tuples as the set of most likely action tuples. In these examples, the determining at block 112 and the causing display at block 114 is for each most likely action tuple of the set of most likely action tuples.

As noted above, in some examples, the process 100 includes selecting a subset of the particular set of particular action tuples as a set of most likely action tuples.

In a first example, the selecting the set of most likely action tuples is based at least in part on respective likelihoods of each particular action tuple of the particular set of particular action tuples. For instance, the respective likelihoods may be predicted using the multi-layer neural network (e.g., best matches, etc.).

In a second example, the selecting the set of most likely action tuples from the particular set of particular action tuples is based at least in part on previously selected and executed options corresponding to previously predicted particular action tuples associated with the particular user. For instance, if similar suggestions were previously presented to the particular user and the particular user repeatedly selected a particular one of the suggestions, then the system may prioritize including such frequently selected type of suggestion in the selected set of most likely action tuples.

In a third example, the selecting the set of most likely action tuples comprises selecting a threshold quantity of action tuples from the particular set of particular action tuples as the set of most likely action tuples. For instance, the particular user may enter a user preference setting that indicates that no more than a certain threshold number of suggestions are to be displayed (e.g., 2, 3, 4, etc.). In this case, the system may select a subset of the particular set of particular action tuples that satisfies the threshold quantity of action tuples.

In some embodiments, the process 100 may include storing data collected during one or more user sessions of the particular user. The stored data may indicate previously selected and executed options corresponding to previously predicted particular action tuples associated with the particular user. The process 100 may also include training a machine learning model to determine the threshold quantity of action tuples based at least in part on the stored data, and using the trained machine learning model to adjust the threshold quantity of action tuples that is to be selected from the particular set of particular action tuples as the set of most likely action tuples. For instance, the system may train the machine learning model to detect that a certain number of action tuples are typically chosen by the particular user typically chooses when a certain action occurs. Thus, in some instances, the threshold quantity of action tuples may be adjusted dynamically for different learned action tuples associated with the particular user.

In block 114, the example system, for a particular action tuple (e.g., or for one or more particular action tuples) of the particular set of particular action tuples, causes display of a particular summary of the particular action tuple and an option to perform a particular user interface navigation to the particular user interface navigation target. For example, the particular summary may include natural language content describing a suggestion or recommendation for performing a next action associated with the particular action tuple (e.g., “First quarter data from several entities was recently uploaded. Would you like to run a consolidation report for the first quarter now?”).

In block 116, the example system executes the option (e.g., for a selected particular action tuple) by causing the particular user interface navigation to the particular user interface navigation target. In an example, the system may cause display of the option as a selectable link (e.g., a hyperlink or other selectable GUI element) in the particular user interface. In this example, the system may execute the option in response to receiving user input selecting the selectable link. For instance, the example system may detect selection of the selected particular action tuple when the particular user selects or interacts with the selectable link via the particular user interface.

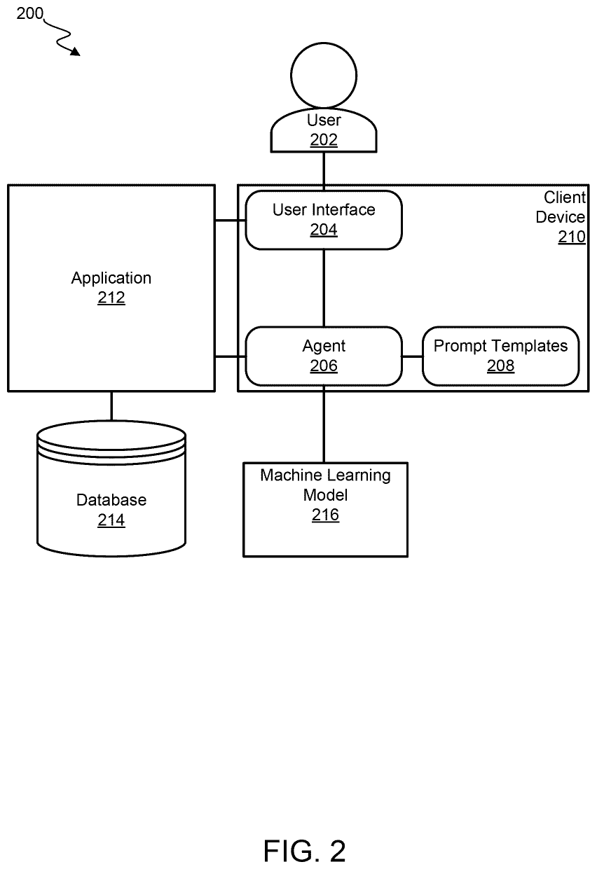

FIG. 2 depicts a sample architecture for an example system 200 to execute the methods and techniques pertaining to at least some embodiments. The User 202 may interact with a User Interface 204 to enter data or view a recommendation from the system 200. For instance, the user interface 204 may include one or more GUIs that are accessible to the user 202 during a user session of the user 202. An Agent 206 is used to communicate between the GUI 204 and the employed machine learning model 216. The Agent 206 may also serve as an intermediary between Prompt Templates 208, the User Interface 204, and/or the application 212. In an example, the prompt templates 208 may include one or more prompts (e.g., recommendations, suggestions) that describe a next action (e.g., in a natural language content format, etc.). The User Interface 204, the Agent 206, and/or the Prompt Template 208 may reside on a Client Device 210 in some embodiments. In other embodiments, one or more components of the system 200 may be distributed among one or more computing devices. In an example, the Client Device 210 may be any personal computing device or other suitable device.

The Application 212 retrieves and sends data to a database 214 based on interactions from User 202 with the User Interface 204. Data from the Database 214 may be made available to the Machine Learning Model 216 via the Application 212 and the Agent 206.

In some examples, the machine learning model 216 may include one or more machine learning models. For example, the machine learning model 216 may include a multi-layer neural network similar to the one described at block 102 of the process 100. As another example, the machine learning model 216 may include one or more machine learning models specific to a particular user. For instance, a first machine learning model may be trained based on user inputs associated with a first user and a second machine learning model may be trained based on user inputs associated with a second user. In some instances, a single user may have more than one user-specific machine learning models. For example, the single user may select a set of action tuples as training data for a first machine learning model (e.g., actions tracked during a particular user session) and a different set of action tuples as training data for a second machine learning model.

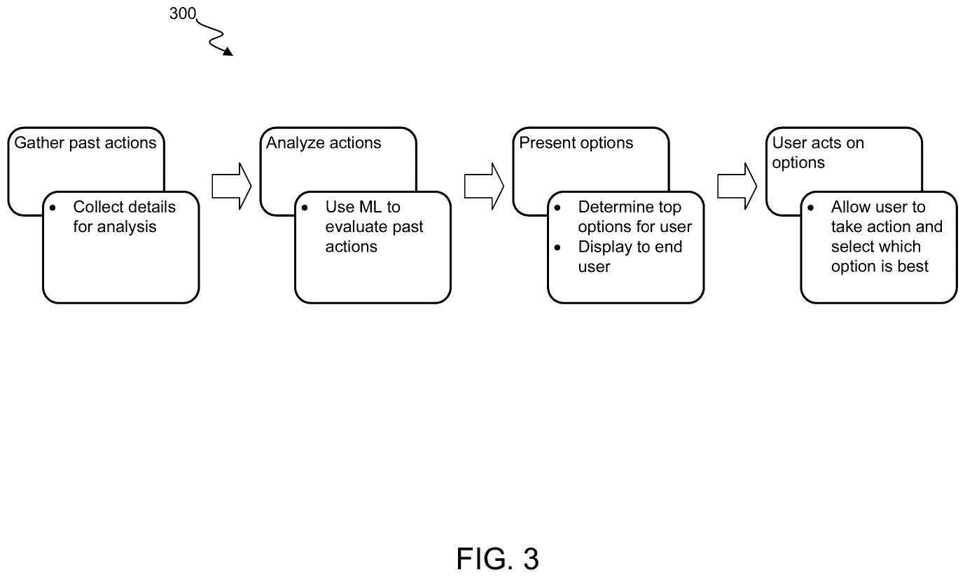

FIG. 3 is a flow chart 300 demonstrating an example sequence of events performed in at least some embodiments. Past user actions may be gathered, and the details of these actions may be collected for analysis. These actions may then be analyzed using a machine learning model evaluating past actions. As a user navigates a GUI, the system presents options to the user based on what are determined to be the top options from the machine learning model and presents those to the user via a display. The user may then act on these options. The system may allow the user to perform an action and select which option is best for their scenario.

### Application Components

In some aspects, an example system (e.g., system 200) may include a settings page (e.g., user interface 204) configured to receive and/or display user settings specific to the user 202. For example, the user settings may include a user setting for a threshold quantity of action tuples to be presented to the user or other settings for selecting a subset of a particular set of particular action tuples as a set of most likely action tuples for the user.

Thus, the Settings Page may allow the user to configure specific aspects of the application (e.g., application 212) that will guide the user experience. For instance, the user may specify the number of recommendations that is returned to the user by the machine learning model (e.g., machine learning model 216).

In some examples, the machine learning recommendations are presented to the user via a GUI. The recommendations may be based on prior user entries from both the current session as well as from previous sessions or reporting periods. In an example, the machine learning model may include a TensorFlow deep learning model. A sample of features that may be entered into the application by the user and whose value may be predicted by the ML model include metadata, ownership, a calculation manager configuration, forms, journals, journal periods, internal reports, intercompany reports, approvals, and jobs.

### Machine Learning (ML) Models

The machine learning model (e.g., 216) may take on different forms and generating using any modern machine learning an AI toolbox, including the open-source machine learning and deep learning framework TensorFlow developed by Google, among other examples. In an example, the machine learning model uses historical data from user inputs and/or current user inputs to predict a sequence of actions. Multiple classes of machine learning models may be used for this purpose including recurrent neural networks (RNNs), transformer models, convolutional neural networks (CNNs) for sequences, such as temporal convolutional networks (TCN), Markov models, encoder-decoder architectures, reinforcement learning models, and/or Bayesian networks, among other possibilities. In an example, the data for the machine learning models may be stored in a database, such as an Excel spreadsheet or any other database, that can be updated in response to user input during a user session. For instance, financial statements may imported into the model from a general ledger that tracks expenses and payments. In an example, outputs, which may include recommendations, predictions, and/or alerts for errors, may be presented to the user in real time via the GUI.

To increase accuracy in predicting the next user action, in an example, the model may incorporate bidirectional loss. Bidirectional loss significantly enhances sequence prediction models by providing a more comprehensive understanding of the data. This approach is particularly beneficial in applications like time series forecasting, where the context from both preceding and succeeding elements is crucial for accurate predictions. By capturing information from both directions in the sequence, for example, the model can make more informed and precise predictions, reducing the likelihood of missing important contextual cues that might otherwise be overlooked.

In an example, the implementation of bidirectional loss involves using two models: one processes the sequence from start to end (forward), while the other processes it in reverse (backward). The forward model generates predictions based on the preceding elements in the sequence, whereas the backward model predicts based on the following elements. This dual approach may allow the model to consider the entire context of the sequence, enhancing its ability to capture complex relationships and dependencies to improve accuracy of predictions.

To effectively apply bidirectional loss, in an example, the losses from both the forward and backward models are calculated and then combined, often through a weighted sum. This combined loss trains the model to align its predictions with the full context of the sequence, improving overall performance and accuracy. Integrating these losses ensures that the model benefits from a comprehensive understanding of the sequence, leading to more precise and reliable outcomes.

In practice, implementing bidirectional loss involves constructing a bidirectional model architecture and defining a custom loss function that integrates the forward and backward losses. In an example, this setup enables the model to leverage the complete contextual information from both directions, making it more effective at capturing intricate patterns and dependencies within the sequence. As a result, in this example, the model achieves better predictive performance and more accurate results.

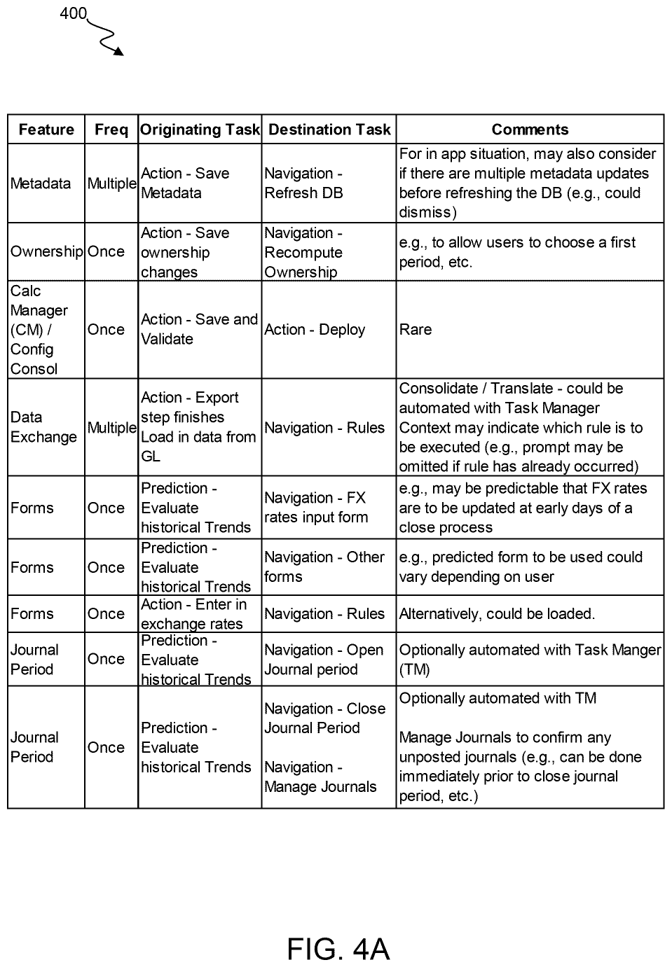

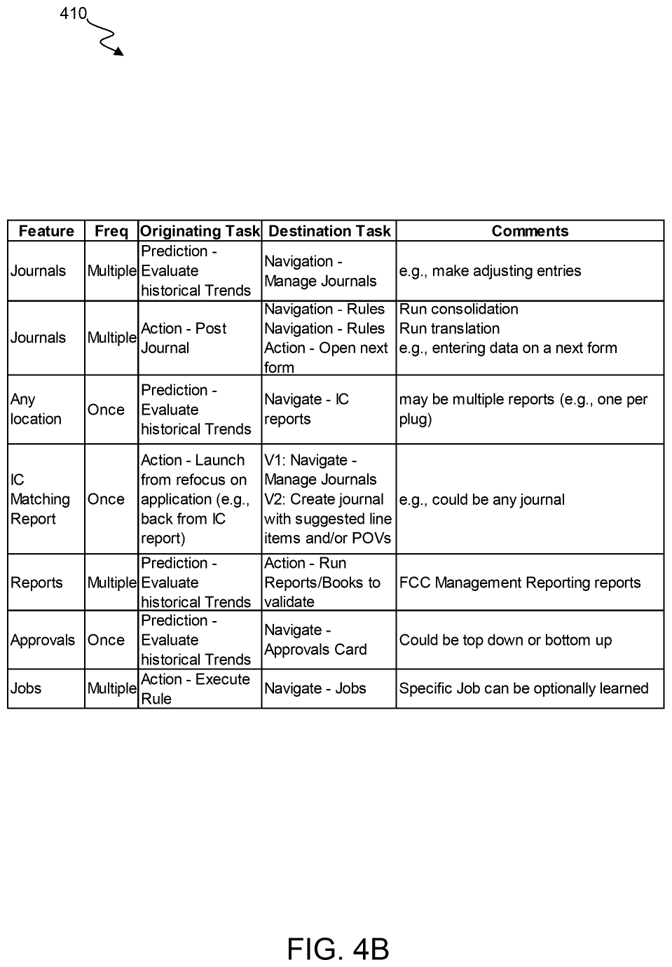

FIG. 4A and FIG. 4B show example tables 400 and 410 illustrating relationships between example user actions associated with the GUI and/or the machine learning model. Each row in the tables 400, 410 may represent an action tuple. An action tuple is a set of related actions. In the illustrated example, the Features column demonstrates common elements (e.g., application features, etc.) that may be included and/or accessed in a Financial Consolidation and Closing (FCC) Report or Application (e.g., application 212). In an example, a user (e.g., administrator user) may edit or access these elements at each reporting cycle. The Originating Task column represents the users input (e.g., one or more actions) at the GUI and the Destination Task column represents the output recommendation (e.g., one or more next actions) provided to the user by the machine learning model, via the GUI. For example, the row associated with the feature ‘Ownership’ describes how a user may engage with the Ownership Feature. If the user saves a change in ownership for a specific element (Originating Task), then the machine learning algorithm may recompute ownership (Destination Task) and suggest the user to choose the first period for this ownership change (Comments).

Another example which illustrates the system's ability to use the machine learning model to predict user behavior is shown in the first row labeled Forms. Here, the model is examining user previous inputs into the GUI and predicts that near this time in the FCC process, the user typically enters in the foreign exchange rate for that period. If the user neglects to enter these values in at this time, the GUI, via input from the ML model, may instruct the user to do so, and so on.

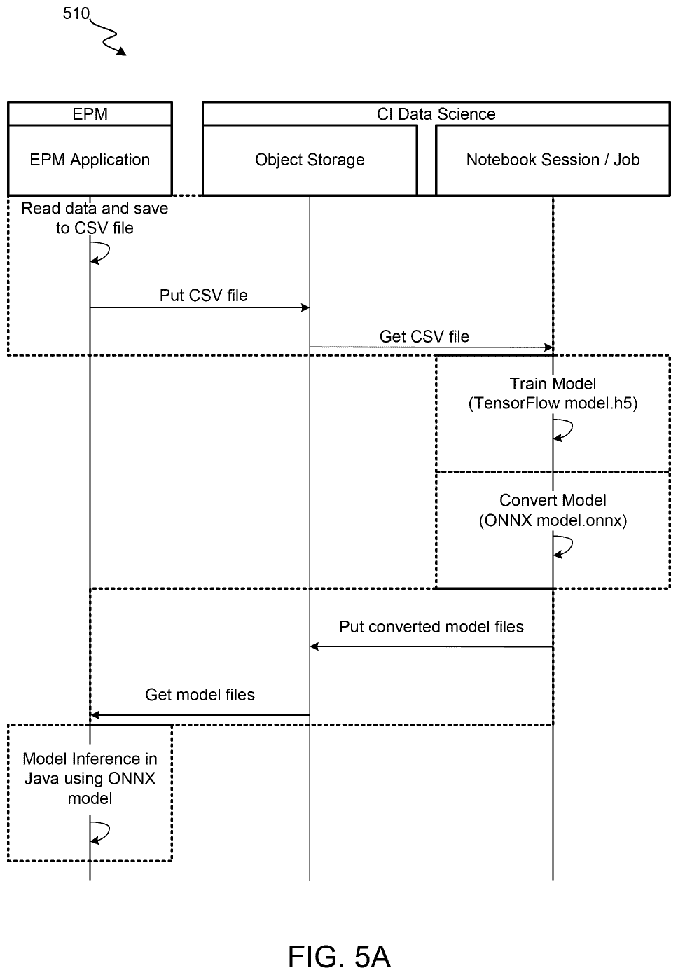

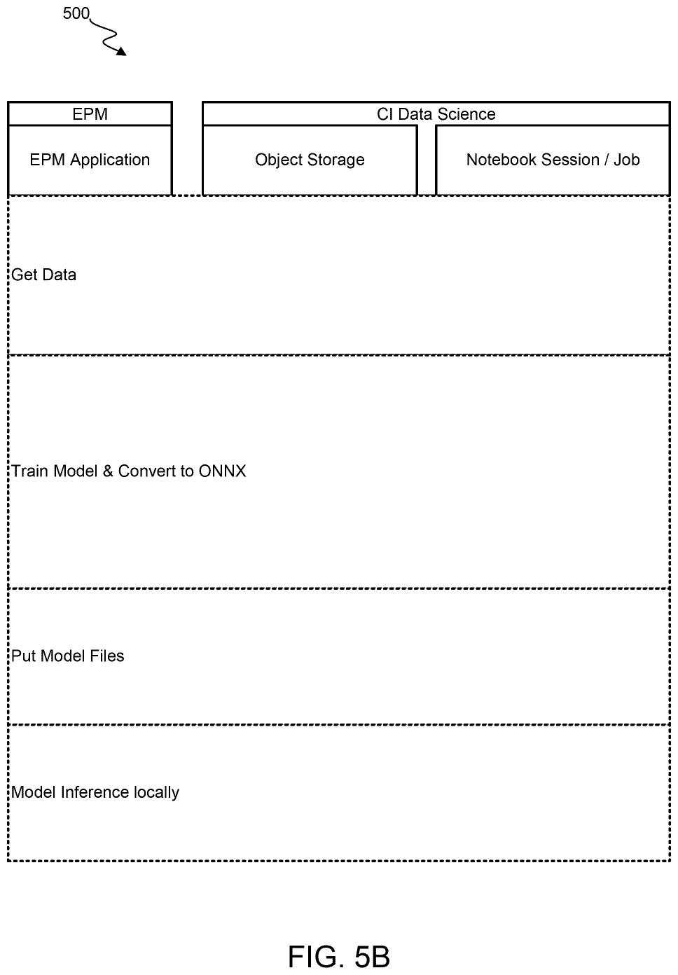

FIG. 5A illustrates an example process 500 for a cloud implementation for training and using a multi-layer neural network to detect a set of learned action tuples. FIG. 5B illustrates another example process 510 for a cloud implementation for training and using a multi-layer neural network to detect a set of learned action tuples.

In some aspects, an example system is configured to host a ML model in a cloud infrastructure. For example, the example system may facilitate making customer audit data available to the ML model, train the ML model in a cloud (e.g., data science cloud), and/or call the trained model to get predictions in an efficient manner (e.g., in milliseconds, etc.).

In some embodiments, an example system is configured to support one or more data retrieval options. In a first example, the system is configured to generate a comma separated file (e.g., CSV file) in the application and use the Object Storage to store a particular data structure corresponding to a set of action tuples for training the ML model. In a second example, the set of action tuples may be read directly from the application (e.g., via ADB and/or as pandas DataFrame).

In some embodiments, an example system is configured to train the ML model based on TensorFlow (e.g., model may be saved in an ‘.h5’ format). In some embodiments, the example system is configured to convert the ML model to an Open Neural Network Exchange (ONNX) format. For example, the system may convert the ML model from an ‘.h5’ format to a ‘.onnx’ format. In an example, the system may run the ONNX model in a Java runtime environment (e.g., using a new jar). In some embodiments, an example system may be configured to optionally operate without using a PMML format, e.g., to improve performance or reduce file size associated with the ML mode.

### Graphical User Interface

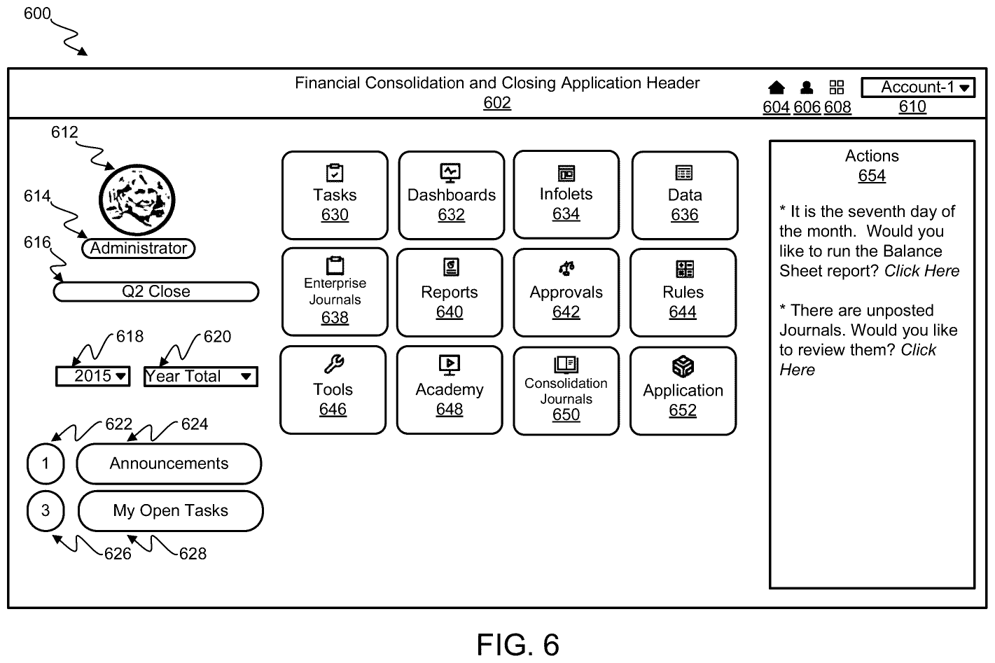

FIG. 6 shows a sample user interface or GUI 600 where an example embodiment, or FCC application, is integrated into a larger Enterprise Performance Management (EPM) platform. Here, an EPM interface may present the user with a prompt to initiate the FCC process based on the time of the period (e.g., first quarter, second quarter, etc.) or another event. The user may also initiate the process without prompting from EPM.

In the illustrated example, the user interface 600 includes an FCC application header bar 602, which includes one or more GUI elements 604, 606, 608, 610 for adjusting or controlling a configuration of a current user session associated with a user of the user interface 600. For example, GUI element 604 can be used to navigate the user interface 600 to a home screen or home interface. For example, GUI element 606 may be selected to navigate to a user preferences or settings page. For example, GUI element 610 may include a selectable input element used to switch between different user profiles, user accounts, user sessions, and/or account profiles. The user interface 600 may also include a user account profile image GUI element 612 configured to display a profile image of the user account. The user interface 600 may also include a user account identifier 614 (e.g., Administrator user). The user interface 600 may also include a GUI element 616 configured to indicate the closing process (e.g., Q2 close) being performed using the FCC application.

The user interface 600 may also include one or more input elements 618, 620 that the user can interact with to choose a data slice. For instance, GUI element 618 can be used to input a fiscal year (e.g., 2015) and GUI element 620 can be used a data view configuration (e.g., year to date, year total, periodic, etc.) that is to be applied when generating reports, etc., using the FCC application. The user interface 600 may also include one or more GUI elements 622, 624, 626, 628 configured to provide notifications to the user. For instance, element 622 may indicate to the user a number of announcements (e.g., new journals submitted by other users for review, etc.) and element 624 can be used to navigate to a user interface that shows a listing of the announcements. Similarly, element 626 may indicate a number of tasks assigned to the user, and the element 628 can be used to navigate the user interface to a listing of the tasks.

The user interface 600 may also include one or more selectable GUI elements 630, 632, 634, 636, 638, 640, 642 644, 646, 648, 650, and 652, which a user can select to navigate (e.g., from the home screen) to various user interface navigation targets (e.g., application features, modules, other user interfaces, etc.) in the FCC application. For example, the user can select GUI element 636 to navigate to a user interface for entering data (e.g., currency exchange rates, etc.) pertaining to the closing process 616.

In some aspects, an example system (e.g., system 200) is configured to track actions performed during one or more user sessions of a particular user (e.g., the administrator user). Furthermore, the system may use the tracked or logged user actions as training data for a ML model (e.g., multi-layer neural network, ML model 216, etc.) to learn a set of action tuples associated with the particular user.

For example, the system may learn that the particular user runs a balance sheet report (e.g., by clicking on the reports 640 UI element) one or more particular days (e.g., seventh day, etc.) of the month during closing processes. Thus, the system may predict, using the machine learning model, that the user may be likely to want to perform a similar action during the current closing process (e.g., second quarter of fiscal year 2015, etc.). For instance, the system may generate a predicted action tuple that predicts a next action (e.g., navigate to the reports 640 user interface to run a balance sheet report for Q2 FY2015) when the day of month is the seventh day of the month. Similarly, the system may use the machine learning model to predict other action tuples comprising a predicted next action, next user interface navigation target, and/or next data slice. The system may then generate one or more summaries of the predicted action tuples and one or more options (e.g., selectable links) that the particular user can use to perform the next action (e.g., navigate to the user interface navigation target, etc.).

By way of example, in the illustrated example, the user interface 600 may include a user interface (e.g., actions 654) that displays one or more summaries (e.g., “It is the seventh day of the month. Would you like to run the Balance Sheet report?”) together with selectable links corresponding to one or more options (e.g., “Click here”) that the particular user can select to accept a particular predicted action tuple.

As the user interacts with the FCC application, various pop-up windows may be generated and presented to the user. These pop-up windows may provide additional suggested actions to the user. The user may then follow up on the initial suggestion, follow up on an additional suggestion, click the delete button to indicate that the suggestion was not relevant, or type in the text entry box to indication an unlisted action that the user wants to take. Such pop-up windows may be presented, for example whenever a user saves a form or posts in a journal. The system may log these user interactions and to use the logged data as training data for the ML model to continuously improve future suggestions (e.g., by selecting a subset of the set of predicted action tuples as a set of most likely action tuples). For instance, the system may adjust the order of the actions 654 displayed in the user interface 600 based on previous selections of previously displayed summaries that were similar to those currently displayed in the actions 654. Alternatively or additionally, the system may omit certain suggestions that the particular user is unlikely to accept (e.g., based on learned user behavior), or adjust the threshold quantity of displayed suggestions or threshold quantity of most likely action tuples selected for the actions 654 in various cases.

When logging into the system initially, the user may be prompted to the first navigation options, for instance returning the user to a journal entry (e.g., “There are unposted Journals. Would you like to review them?”). Here, for instance, the system may evaluate the last few modules from one or more previous user sessions of the user, and/or based on a most recently used module (e.g., the user may have been working on a consolidation journal using the consolidation journals 650 module in the previous user session).

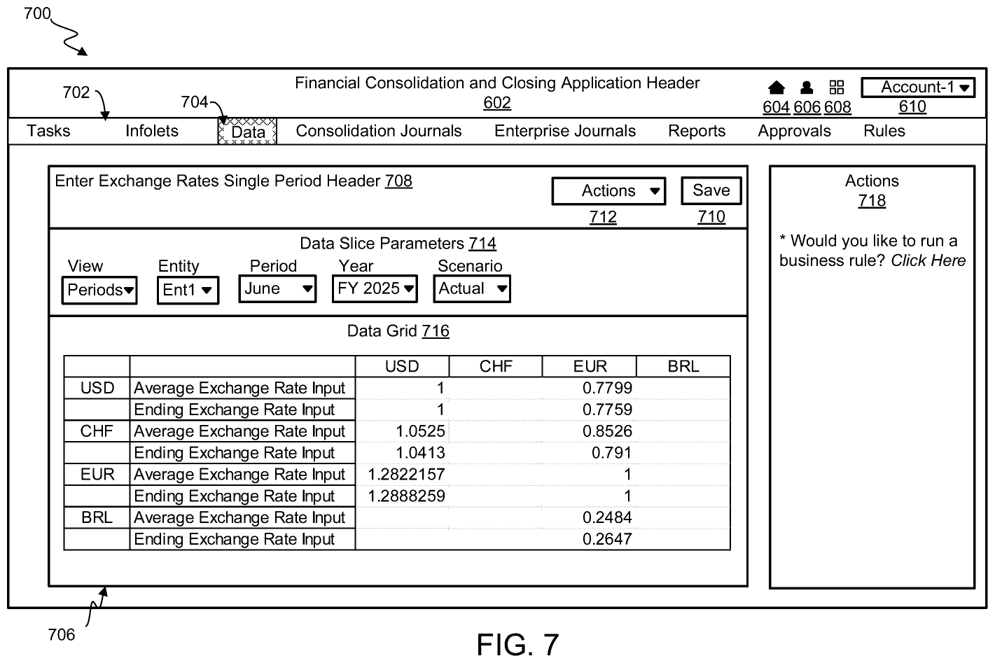

FIG. 7 illustrates an example user interface 700 that shows an exemplary case of a user interacting with the Foreign Exchange Rates module (e.g., accessed by selecting the GUI element 636 of the GUI 600, etc.). In the illustrated example, the user interface 700 may include a navigation bar 702 which includes a plurality of selectable UI elements for navigating to one or more modules of the FCC application. For instance, the currently selected module 704 (‘Data’) causes the UI 700 to display the user interface 706, which the user can interact with to update currency exchange rates used to perform FCC calculations on a particular data slice (e.g., financial data in the period of June, the fiscal year 2025, etc.).

The UI 706 may include a header 708 that includes a title describing the UI 706 (e.g., “Enter Exchange Rates—Single Period”). The UI 706 also includes one or more UI input elements 710, 712 for performing one or more actions with respect to the data displayed in the UI 706. For example, a user can select the save button 710 to store data entered or updated in data grid 716. The UI 706 may also include one or more data slice parameters 714 (e.g., View, Entity, Period, Year, Scenario, etc.) which the user can adjust to define the data slice (e.g., in a multi-dimensional dataset) for which the entered or updated data in the data grid 716 is to be applied. For instance, with the settings depicted, the user can update the currency exchange rate of a particular currency pair (e.g., USD/EUR, etc.) only for financial data that corresponds to Entity ‘Ent1’, ‘June’ period, year ‘FY2025’, scenario ‘Actual’, etc.

In an example, the user can enter in exchange rates and click the save button 710. In this example, the system may have predicted an action tuple for the user, where the user tends to run business rules after he updates currency exchange rates. Thus, the system may present to the user, in actions pane 718 for example, a suggestion based on the predicted action tuple (e.g., “Would you like to run a business rule?”). For instance, the user may be presented with a prompt to execute a business rule because calculations may depend on exchange rates (e.g., which the system may have additionally or alternatively learned based on historical user behavior). The prompt may remind the user to execute such rules.

An additional example may include a user interacting with the Journal module. Once the user completes that entry and submits for approval, the system may also trigger a prompt to execute specific business rules pertaining to those data entries.

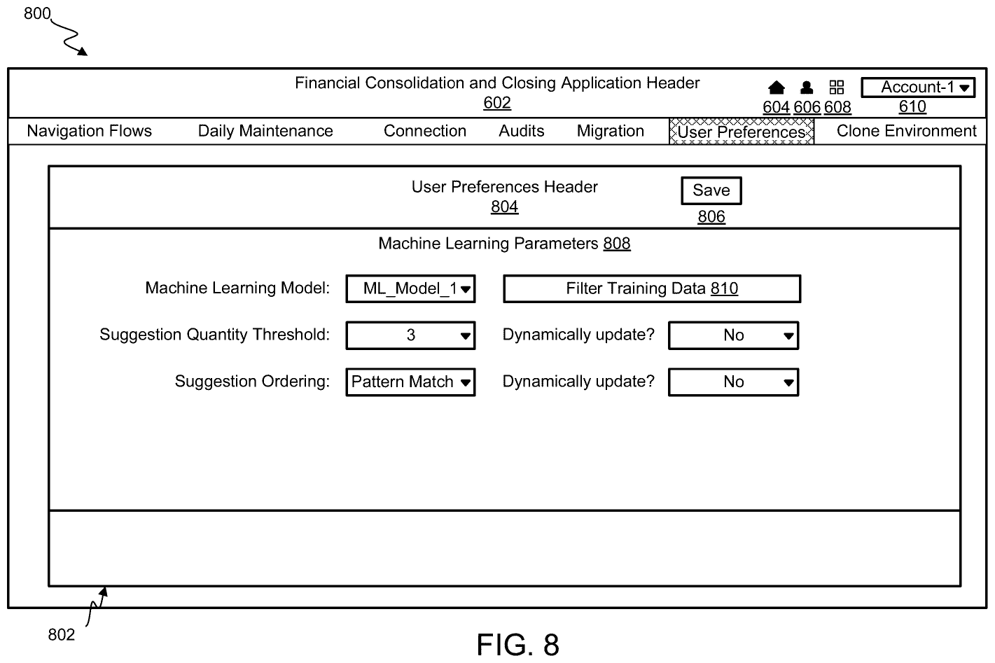

FIG. 8 shows a sample configuration screen 800 where the user may tailor the application and GUI to their user-specific or task-specific preferences. The UI 800 may include a header 804 and a save button 806 to store updates to the user preferences. The system may be configured to display the user interface 802 to the user for adjusting user preferences associated with various machine learning parameters 808. For example, the system can apply a user-selected machine learning model (e.g., ‘Machine Learning Model’ setting of ‘ML_Model_1). For example, the user can filter which user actions should be used to train the machine learning model using UI element 810. For example, the interface may be configured to return a specific number of outputs (e.g., ‘Suggestion Quantity Threshold’) from the machine learning algorithm based on a user-defined threshold (e.g., ‘3’) indicated in the UI 802. For example, the system can optionally be configured by the user to dynamically update the suggestion quantity threshold based on user behavior (e.g., ‘Dynamically update?’ setting of ‘Yes’). For example, the system can order the displayed suggestions based on their predicted likelihood indicated by the machine learning model (e.g., ‘Suggestion Ordering Setting’ of ‘Pattern Match’) or based on how often the user accepts a certain type of suggestion (e.g., by setting the ‘Dynamically update?’ setting to ‘Yes’). These settings may determine how many further prompts the user receives upon closing out a journal entry for example.

Generating and Learning from Next Action Tuples

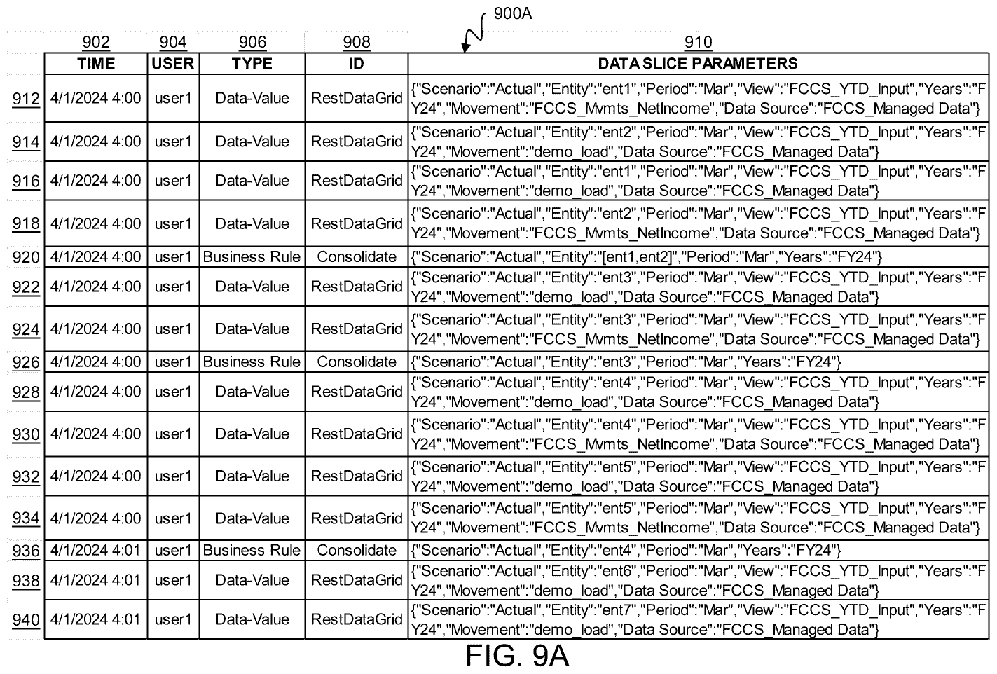

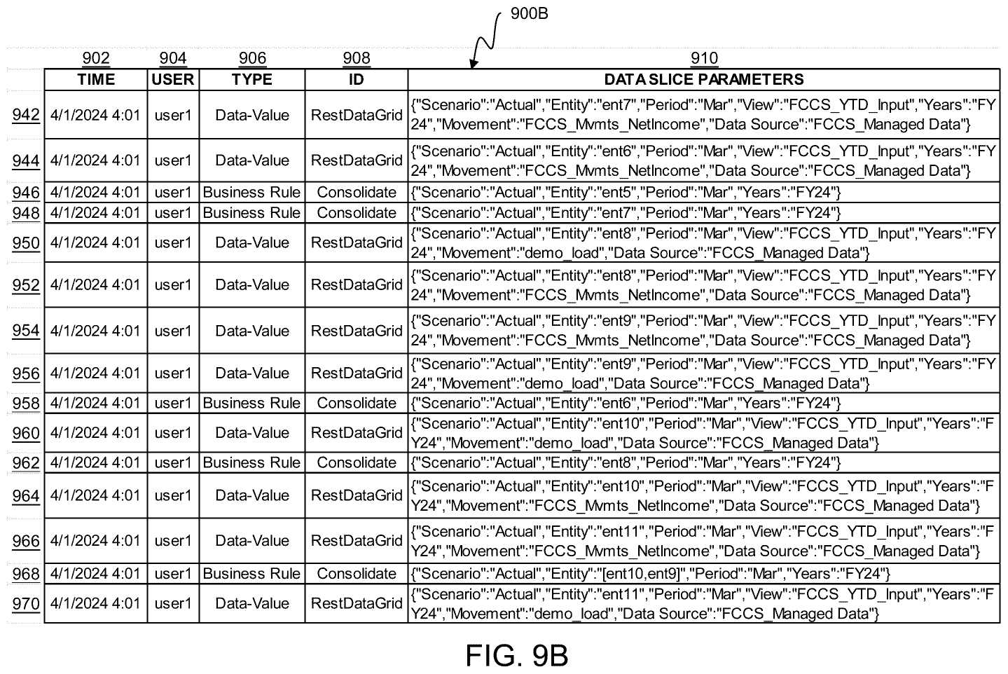

FIG. 9A and FIG. 9B illustrate an example table 900A to 900B that shows an example of the data entry into the machine learning model and how such data may be stored and organized. In particular, rows 912-940 of table 900A are depicted in FIG. 9A and rows 942-970 of table 900B are depicted in FIG. 9B. It will be appreciated that other forms of data storage and organization may also be employed without departing from the scope of the present disclosure.

Column 902 shows a time stamp indicating when a parameter in the model was changed via a user input and/or when an action was performed by the user of the FCC application, e.g., via the GUI. The second column 904 tracks the user that input the data into the GUI and/or performed the action. Column 906 tracks the type of interaction that the user had with the GUI. For instance, this may take the form of changing the value of a data point or parameter (e.g., ‘Data-Value). Alternatively, the interaction may take the form of implementing a business rule. In general, implementing a business rule involves executing a pre-configured data processing operation to generate calculated values, reports, and/or other output based on a particular data slice of multidimensional data. The fourth column 910 (labeled ‘ID’) specifies a user interface functionality used by the user, such as viewing or configuring a RestDataGrid or performance of a business rule to consolidate values. Column 910 (labeled ‘DATA SLICE PARAMETERS’) shows the various parameters used by the model and how they are delimited. For instance, at row 912, an action was performed by the GUI that involves entering or updating data values that are applicable to a data slice corresponding to the parameters in row 912, column 910 (e.g., scenario=‘Actual’, Entity=‘ent1’, etc.). In the illustrated example, the various parameters are separated by commas, and the value of each parameter is separated from the name of the parameter by a semicolon.

In an example, as the value of parameters are changed during a user session and/or if the user performs an action associated with a different combination of parameters, a new row may be created by the system with a time stamp of the event in column 902, the user's identity in column 904, the action type that was performed column 906, the model recommendation or the mode of data entry or the module associated with action, etc., in column 908, and the new model parameter values in column 910.

Column 910 of FIG. 9A and FIG. 9B shows the various types of data (e.g., dimensions of a multidimensional dataset) that may be used for the machine learning mode and the type of data that the user may input. This data may include the Period for the FCC report, the Years, the Data Source, and financial statements stored in parameters such as FCCS, etc.

The machine learning model may predict tuples that describe a next action (e.g., adjacent row of table 900A to 900B) or a next user interface, which is a next adjacent row of column 908 that is not known to the machine learning model (e.g., not yet performed by the user in the GUI). The machine learning model may also predict a next operation to be performed on the user interface, such as consolidation of a business rule or updating of stored values as indicated by the parameters in column 910 for the next row. Further, the machine learning model may predict a next data slice involved in the next interaction, such as a data slice of the next row indicated by the parameters of column 910.

In some examples, the machine learning model is trained at least in part by randomly selecting adjacent groups of user inputs, such as rows 912-918, rows 944-950, and rows 962-968 to predict a sequentially next user input, such as row 920, row 952, and row 970, respectively. The machine learning model may also be trained by randomly selecting adjacent groups of user inputs, such as rows 934-940, rows 946-952, and rows 960-966 to predict a sequentially previous user input, such as row 932, 944, and 958, respectively. Any characteristics of FIG. 9A and FIG. 9B may be predicted for the next or previous row, and the recurring data patterns of those characteristics may be adopted by the machine learning model in making predictions for other adjacent groups or for new groups that are not in the dataset of FIG. 9A and FIG. 9B. For example, if the machine learning model detects a pattern similar to rows 928-934 but with different parameters such as a different entity, year, period, etc., the system may still predict a next action similar to row 936 but with different entity, period, year, etc., parameters that, e.g., match those of the new set of detected actions. On a characteristic-by-characteristic basis and for the characteristics as a whole, the machine learning model may be graded as making an accurate prediction when the hidden row is accurately predicted and an inaccurate prediction when the hidden row is inaccurately predicted. Example characteristics that are predicted include the user interface that will be in use, the action or operation that will be performed, and the data slice that will be involved in the next action or operation.

In an example, as new user input is received, the new user input, as well as optionally one or more items of input preceding the new user input (e.g., more prior input to detect longer-term patterns), are provided to the machine learning model. The current and prior user input processed may include details about current and prior user interfaces visited, operations performed, and data slices (intersections of dimension members) involved in each of the items of user input, or any characteristics such as the ones shown in FIG. 9A and FIG. 9B. Such user inputs may be received as a tuple, such as one or more rows of information in FIG. 9A and/or FIG. 9B or any other encapsulated information that is packaged together. The machine learning model processes the current and past user inputs to determine a next user interaction, which may include a next user interface, a next operation, and/or a next data slice involved in the next operation, and/or any other characteristics of FIG. 9A and/or FIG. 9B.

Upon determining a next action tuple describing a next user interaction, the system may cause display of a particular summary of the next action tuple and an option to perform a particular user interface navigation to the particular user interface navigation target to accomplish the next predicted operation on the next predicted tuple using the next predicted interface. Upon selection of the option, the system modifies the user's application session to view the particular user interface navigation target with additional options to perform the next predicted operation in relation to the next predicted slice of data.

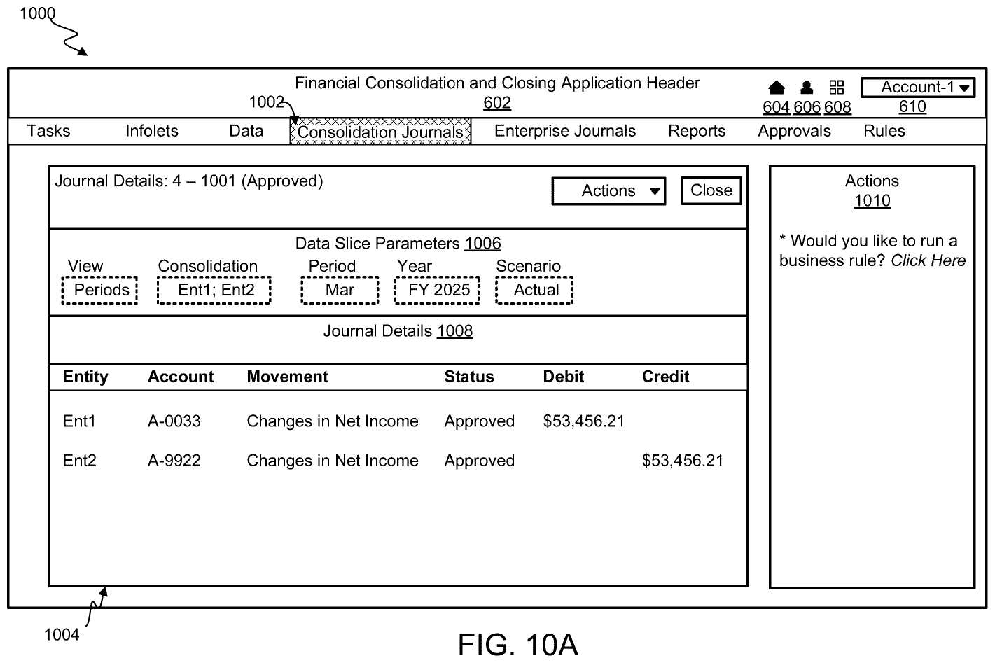

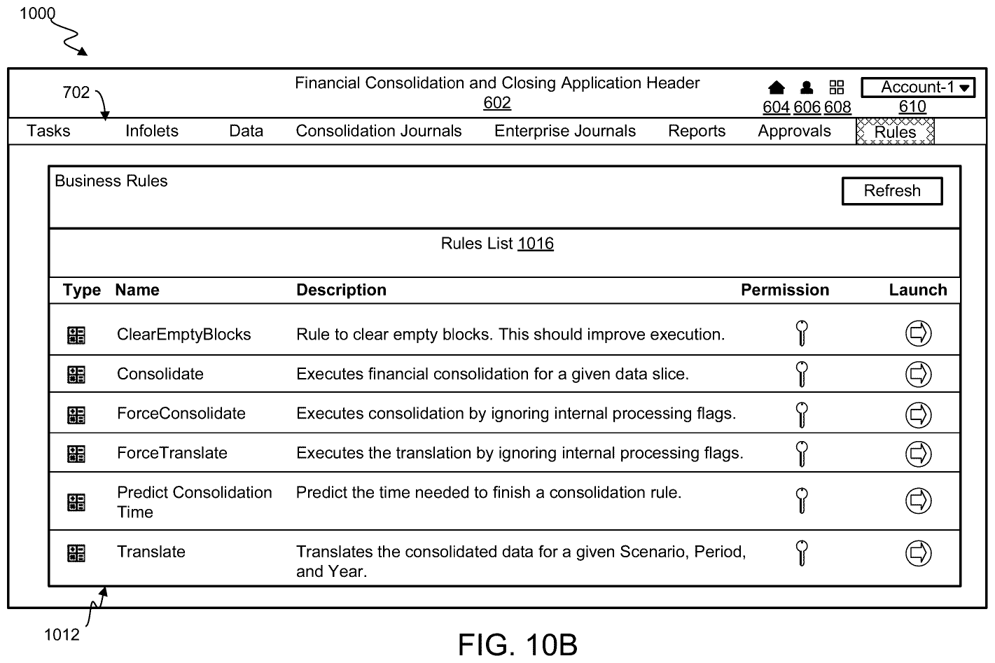

FIG. 10A and FIG. 10B show how the recommendation of the model is integrated with an example GUI 1000. In this example, a user has completed a post journal entry. For instance, as shown in FIG. 10A, the GUI 1000 includes a journal details UI 1004 that displays a summary of data slice parameters 1006 and journal details 1008 associated with the Journal entry. In this example, the GUI 1000 now prompts the user if they would like to execute a business rule. For instance, as shown in FIG. 10A, the GUI 1000 displays a recommended actions UI 1010 that includes a summary of the predicted next action (e.g., “Would you like to run a business rule?”) together with a selectable option (e.g., “Click Here”) for the user to accept the recommendation. If the user clicks on the system generated hyperlink (e.g., “Click Here”), the GUI 1000 may then execute the option by navigating to a UI 1012 of the business journals modules. For instance, as shown in FIG. 10B, the GUI 1000 may open a page allowing the user to select a specific business rule from the rules list 1016. An additional example might include an instance in which a user reviews an intercompany report, the user may be prompted to initiate a journal entry related to the intercompany report.

### Computer System Architecture

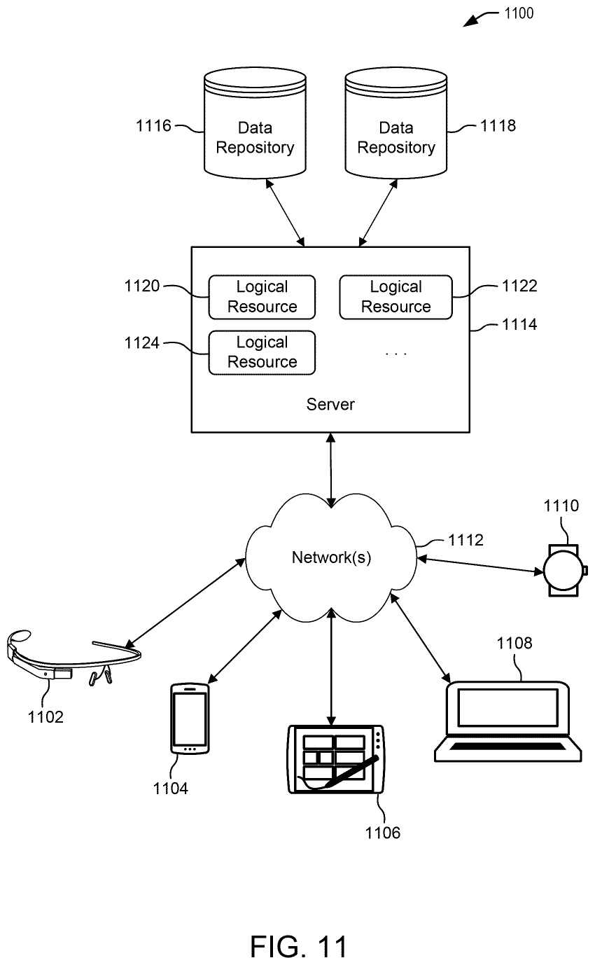

FIG. 11 depicts a simplified diagram of a distributed system 1100 for implementing an embodiment. In the illustrated embodiment, distributed system 1100 includes one or more client computing devices 1102, 1104, 1106, 1108, and/or 1110 coupled to a server 1114 via one or more communication networks 1112. Clients computing devices 1102, 1104, 1106, 1108, and/or 1110 may be configured to execute one or more applications.

In various aspects, server 1114 may be adapted to run one or more services or software applications that enable techniques for training and using a multi-layer neural network to detect a set of most likely action tuples each comprising a next user interface, a next operation, and a next data slice at least in part by training the multi-layer neural network to predict sequentially next user input and sequentially previous user input for adjacent groups.

In certain aspects, server 1114 may also provide other services or software applications that can include non-virtual and virtual environments. In some aspects, these services may be offered as web-based or cloud services, such as under a Software as a Service (SaaS) model to the users of client computing devices 1102, 1104, 1106, 1108, and/or 1110. Users operating client computing devices 1102, 1104, 1106, 1108, and/or 1110 may in turn utilize one or more client applications to interact with server 1114 to utilize the services provided by these components.

In the configuration depicted in FIG. 11, server 1114 may include one or more components 1120, 1122 and 1124 that implement the functions performed by server 1114. These components may include software components that may be executed by one or more processors, hardware components, or combinations thereof. It should be appreciated that various different system configurations are possible, which may be different from distributed system 1100. The embodiment shown in FIG. 11 is thus one example of a distributed system for implementing an embodiment system and is not intended to be limiting.

Users may use client computing devices 1102, 1104, 1106, 1108, and/or 1110 for techniques for training and using a multi-layer neural network to detect a set of most likely action tuples each comprising a next user interface, a next operation, and a next data slice at least in part by training the multi-layer neural network to predict sequentially next user input and sequentially previous user input for adjacent groups in accordance with the teachings of this disclosure. A client device may provide an interface that enables a user of the client device to interact with the client device. The client device may also output information to the user via this interface. Although FIG. 11 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1112 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1112 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1114 may be composed of one or more general purpose computers, specialized server computers (including, by way of example, PC (personal computer) servers, UNIX® servers, LINUX© servers, mid-range servers, mainframe computers, rack-mounted servers, etc.), server farms, server clusters, a Real Application Cluster (RAC), database servers, or any other appropriate arrangement and/or combination. Server 1114 can include one or more virtual machines running virtual operating systems, or other computing architectures involving virtualization such as one or more flexible pools of logical storage devices that can be virtualized to maintain virtual storage devices for the server. In various aspects, server 1114 may be adapted to run one or more services or software applications that provide the functionality described in the foregoing disclosure.

The computing systems in server 1114 may run one or more operating systems including any of those discussed above, as well as any commercially available server operating system. Server 1114 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1114 may include one or more applications to analyze and consolidate data feeds and/or event updates received from users of client computing devices 1102, 1104, 1106, 1108, and/or 1110. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1114 may also include one or more applications to display the data feeds and/or real-time events via one or more display devices of client computing devices 1102, 1104, 1106, 1108, and/or 1110.

Distributed system 1100 may also include one or more data repositories 1116, 1118. These data repositories may be used to store data and other information in certain aspects. For example, one or more of the data repositories 1116, 1118 may be used to store information for techniques for training and using a multi-layer neural network to detect a set of most likely action tuples each comprising a next user interface, a next operation, and a next data slice at least in part by training the multi-layer neural network to predict sequentially next user input and sequentially previous user input for adjacent groups. Data repositories 1116, 1118 may reside in a variety of locations. For example, a data repository used by server 1114 may be local to server 1114 or may be remote from server 1114 and in communication with server 1114 via a network-based or dedicated connection. Data repositories 1116, 1118 may be of different types. In certain aspects, a data repository used by server 1114 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1116, 1118 may also be used by applications to store application data. The data repositories used by applications may be of different types such as, for example, a key-value store repository, an object store repository, or a general storage repository supported by a file system.

In one embodiment, server 1114 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

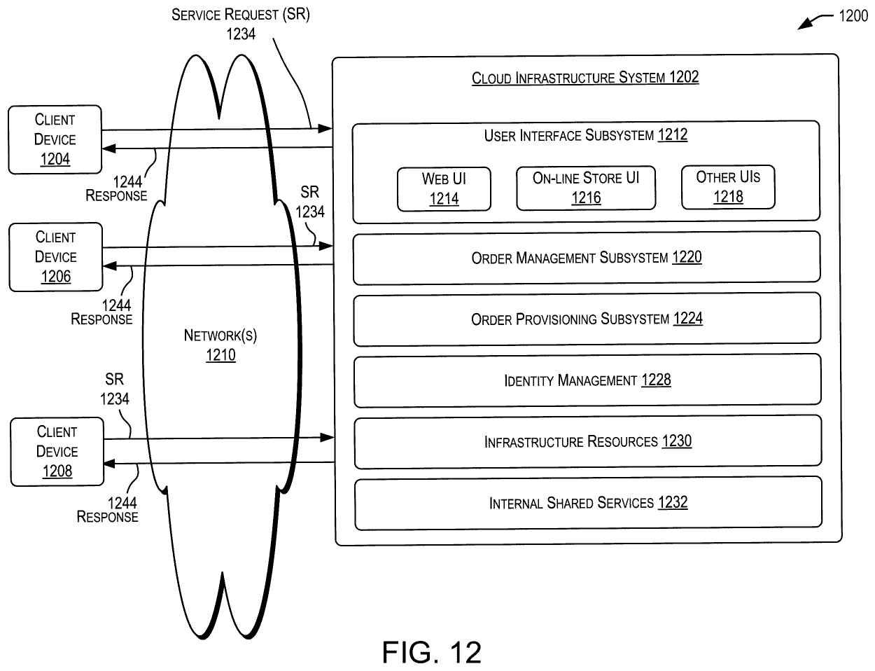

FIG. 12 is a simplified block diagram of a cloud-based system environment that trains and uses a multi-layer neural network to detect a set of most likely action tuples each comprising a next user interface, a next operation, and a next data slice at least in part by training the multi-layer neural network to predict sequentially next user input and sequentially previous user input for adjacent groups, in accordance with certain aspects. In the embodiment depicted in FIG. 12, cloud infrastructure system 1202 may provide one or more cloud services that may be requested by users using one or more client computing devices 1204, 1206, and 1208. Cloud infrastructure system 1202 may comprise one or more computers and/or servers that may include those described above for server 1114. The computers in cloud infrastructure system 1202 may be organized as general purpose computers, specialized server computers, server farms, server clusters, or any other appropriate arrangement and/or combination.

Network(s) 1210 may facilitate communication and exchange of data between clients 1204, 1206, and 1208 and cloud infrastructure system 1202. Network(s) 1210 may include one or more networks. The networks may be of the same or different types. Network(s) 1210 may support one or more communication protocols, including wired and/or wireless protocols, for facilitating the communications.

The embodiment depicted in FIG. 12 is only one example of a cloud infrastructure system and is not intended to be limiting. It should be appreciated that, in some other aspects, cloud infrastructure system 1202 may have more or fewer components than those depicted in FIG. 12, may combine two or more components, or may have a different configuration or arrangement of components. For example, although FIG. 12 depicts three client computing devices, any number of client computing devices may be supported in alternative aspects.

The term cloud service is generally used to refer to a service that is made available to users on demand and via a communication network such as the Internet by systems (e.g., cloud infrastructure system 1202) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1210 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1202 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1202 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1202. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1202. Cloud infrastructure system 1202 then performs processing to provide the services requested in the tenant's subscription order. Cloud infrastructure system 1202 may be configured to provide one or even multiple cloud services.

Cloud infrastructure system 1202 may provide the cloud services via different deployment models. In a public cloud model, cloud infrastructure system 1202 may be owned by a third party cloud services provider and the cloud services are offered to any general public tenant, where the tenant can be an individual or an enterprise. In certain other aspects, under a private cloud model, cloud infrastructure system 1202 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1202 and the services provided may be shared by several organizations in a related community. Various other models such as hybrids of the above mentioned models may also be used.

Client computing devices 1204, 1206, and 1208 may be of different types (such as devices 1102, 1104, 1106, and 1108 depicted in FIG. 11) and may be capable of operating one or more client applications. A user may use a client device to interact with cloud infrastructure system 1202, such as to request a service provided by cloud infrastructure system 1202.

In some aspects, the processing performed by cloud infrastructure system 1202 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1202 for determining the intent of an utterance. The data used for this analysis may include structured data (e.g., data stored in a database or structured according to a structured model) and/or unstructured data (e.g., data blobs (binary large objects)).

As depicted in the embodiment in FIG. 12, cloud infrastructure system 1202 may include infrastructure resources 1230 that are utilized for facilitating the provision of various cloud services offered by cloud infrastructure system 1202. Infrastructure resources 1230 may include, for example, processing resources, storage or memory resources, networking resources, and the like.

In certain aspects, to facilitate efficient provisioning of these resources for supporting the various cloud services provided by cloud infrastructure system 1202 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1202 may itself internally use services 1232 that are shared by different components of cloud infrastructure system 1202 and which facilitate the provisioning of services by cloud infrastructure system 1202. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1202 may comprise multiple subsystems. These subsystems may be implemented in software, or hardware, or combinations thereof. As depicted in FIG. 12, the subsystems may include a user interface subsystem 1212 that enables users of cloud infrastructure system 1202 to interact with cloud infrastructure system 1202. User interface subsystem 1212 may include various different interfaces such as a web interface 1214, an online store interface 1216 where cloud services provided by cloud infrastructure system 1202 are advertised and are purchasable by a consumer, and other interfaces 1218. For example, a tenant may, using a client device, request (service request 1234) one or more services provided by cloud infrastructure system 1202 using one or more of interfaces 1214, 1216, and 1218. For example, a tenant may access the online store, browse cloud services offered by cloud infrastructure system 1202, and place a subscription order for one or more services offered by cloud infrastructure system 1202 that the tenant wishes to subscribe to. The service request may include information identifying the tenant and one or more services that the tenant desires to subscribe to. For example, a tenant may place a subscription order for a chatbot related service offered by cloud infrastructure system 1202. As part of the order, the client may provide information identifying the input (e.g. utterances).

In certain aspects, such as the embodiment depicted in FIG. 12, cloud infrastructure system 1202 may comprise an order management subsystem (OMS) 1220 that is configured to process the new order. As part of this processing, OMS 1220 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1220 may then invoke the order provisioning subsystem (OPS) 1224 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1224 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1202 may send a response or notification 1244 to the requesting tenant to indicate when the requested service is now ready for use. In some instances, information (e.g., a link) may be sent to the tenant that enables the tenant to start using and availing the benefits of the requested services.

Cloud infrastructure system 1202 may provide services to multiple tenants. For each tenant, cloud infrastructure system 1202 is responsible for managing information related to one or more subscription orders received from the tenant, maintaining tenant data related to the orders, and providing the requested services to the tenant or clients of the tenant. Cloud infrastructure system 1202 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1202 may provide services to multiple tenants in parallel. Cloud infrastructure system 1202 may store information for these tenants, including possibly proprietary information. In certain aspects, cloud infrastructure system 1202 comprises an identity management subsystem (IMS) 1228 that is configured to manage tenant's information and provide the separation of the managed information such that information related to one tenant is not accessible by another tenant. IMS 1228 may be configured to provide various security-related services such as identity services, such as information access management, authentication and authorization services, services for managing tenant identities and roles and related capabilities, and the like.

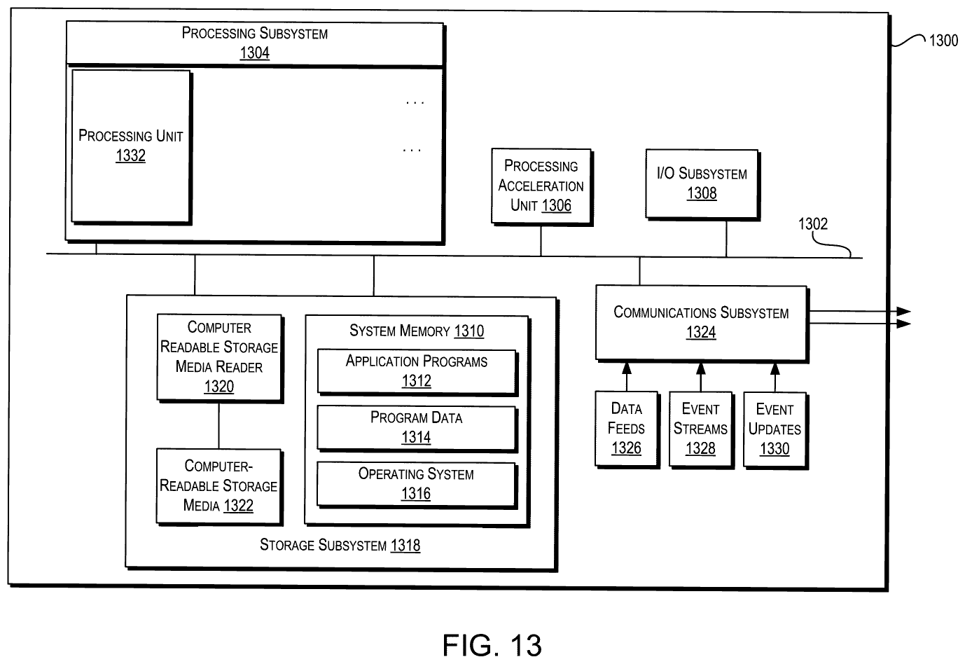

FIG. 13 illustrates an exemplary computer system 1300 that may be used to implement certain aspects. As shown in FIG. 13, computer system 1300 includes various subsystems including a processing subsystem 1304 that communicates with a number of other subsystems via a bus subsystem 1302. These other subsystems may include a processing acceleration unit 1306, an I/O subsystem 1308, a storage subsystem 1318, and a communications subsystem 1324. Storage subsystem 1318 may include non-transitory computer-readable storage media including storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative aspects of the bus subsystem may utilize multiple buses. Bus subsystem 1302 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1304 controls the operation of computer system 1300 and may comprise one or more processors, application specific integrated circuits (ASICs), or field programmable gate arrays (FPGAs). The processors may be single core or multicore processors. The processing resources of computer system 1300 can be organized into one or more processing units 1332, 1334, etc. A processing unit may include one or more processors, one or more cores from the same or different processors, a combination of cores and processors, or other combinations of cores and processors. In some aspects, processing subsystem 1304 can include one or more special purpose co-processors such as graphics processors, digital signal processors (DSPs), or the like. In some aspects, some or all of the processing units of processing subsystem 1304 can be implemented using customized circuits, such as application specific integrated circuits (ASICs), or field programmable gate arrays (FPGAs).

In some aspects, the processing units in processing subsystem 1304 can execute instructions stored in system memory 1310 or on computer readable storage media 1322. In various aspects, the processing units can execute a variety of programs or code instructions and can maintain multiple concurrently executing programs or processes. At any given time, some or all of the program code to be executed can be resident in system memory 1310 and/or on computer-readable storage media 1322 including potentially on one or more storage devices. Through suitable programming, processing subsystem 1304 can provide various functionalities described above. In instances where computer system 1300 is executing one or more virtual machines, one or more processing units may be allocated to each virtual machine.

In certain aspects, a processing acceleration unit 1306 may optionally be provided for performing customized processing or for off-loading some of the processing performed by processing subsystem 1304 so as to accelerate the overall processing performed by computer system 1300.

I/O subsystem 1308 may include devices and mechanisms for inputting information to computer system 1300 and/or for outputting information from or via computer system 1300. In general, use of the term input device is intended to include all possible types of devices and mechanisms for inputting information to computer system 1300. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1300 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1318 provides a repository or data store for storing information and data that is used by computer system 1300. Storage subsystem 1318 provides a tangible non-transitory computer-readable storage medium for storing the basic programming and data constructs that provide the functionality of some aspects. Storage subsystem 1318 may store software (e.g., programs, code modules, instructions) that when executed by processing subsystem 1304 provides the functionality described above. The software may be executed by one or more processing units of processing subsystem 1304. Storage subsystem 1318 may also provide a repository for storing data used in accordance with the teachings of this disclosure.

Storage subsystem 1318 may include one or more non-transitory memory devices, including volatile and non-volatile memory devices. As shown in FIG. 13, storage subsystem 1318 includes a system memory 1310 and a computer-readable storage media 1322. System memory 1310 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1300, such as during start-up, may typically be stored in the ROM. The RAM typically contains data and/or program modules that are presently being operated and executed by processing subsystem 1304. In some implementations, system memory 1310 may include multiple different types of memory, such as static random access memory (SRAM), dynamic random access memory (DRAM), and the like.

By way of example, and not limitation, as depicted in FIG. 13, system memory 1310 may load application programs 1312 that are being executed, which may include various applications such as Web browsers, mid-tier applications, relational database management systems (RDBMS), etc., program data 1314, and an operating system 1316. By way of example, operating system 1316 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1322 may store programming and data constructs that provide the functionality of some aspects. Computer-readable media 1322 may provide storage of computer-readable instructions, data structures, program modules, and other data for computer system 1300. Software (programs, code modules, instructions) that, when executed by processing subsystem 1304 provides the functionality described above, may be stored in storage subsystem 1318. By way of example, computer-readable storage media 1322 may include non-volatile memory such as a hard disk drive, a magnetic disk drive, an optical disk drive such as a CD ROM, digital video disc (DVD), a Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1318 may also include a computer-readable storage media reader 1320 that can further be connected to computer-readable storage media 1322. Reader 1320 may receive and be configured to read data from a memory device such as a disk, a flash drive, etc.

In certain aspects, computer system 1300 may support virtualization technologies, including but not limited to virtualization of processing and memory resources. For example, computer system 1300 may provide support for executing one or more virtual machines. In certain aspects, computer system 1300 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1300. Accordingly, multiple operating systems may potentially be run concurrently by computer system 1300.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to establish a communication channel to one or more client devices via the Internet for receiving and sending information from and to the client devices. For example, the communications subsystem may be used to transmit a response to a user regarding the inquiry for a chatbot.

Communications subsystem 1324 may support both wired and/or wireless communication protocols. For example, in certain aspects, communications subsystem 1324 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1324 can provide wired network connectivity (e.g., Ethernet) in addition to or instead of a wireless interface.

Communications subsystem 1324 can receive and transmit data in various forms. For example, in some aspects, in addition to other forms, communications subsystem 1324 may receive input communications in the form of structured and/or unstructured data feeds 1326, event streams 1328, event updates 1330, and the like. For example, communications subsystem 1324 may be configured to receive (or send) data feeds 1326 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1324 may be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to communicate data from computer system 1300 to other computer systems or networks. The data may be communicated in various different forms such as structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1300 depicted in FIG. 13 is intended only as a specific example. Many other configurations having more or fewer components than the system depicted in FIG. 13 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
training a multi-layer neural network to detect a set of learned action tuples each comprising a next user interface, a next operation, and a next data slice, wherein the multi-layer neural network is trained at least in part by randomly selecting adjacent groups of user inputs to predict a sequentially next user input, and wherein the multi-layer neural network is also trained at least in part by randomly selecting adjacent groups of user inputs to predict a sequentially previous user input, wherein the multi-layer neural network is trained on one or more vector embeddings comprising a data slice in use, an interface in use, and an operation being performed at adjacent times;
receiving particular input from a particular user as the particular user navigates to a particular user interface to perform one or more tasks against multidimensional data;
detecting that the particular input causes a particular operation to be performed on the particular user interface with respect to a particular data slice;
storing a particular data structure that identifies the particular operation, the particular user interface, and the particular data slice;
providing the particular data structure as input to the multi-layer neural network to predict a particular set of particular action tuples, each comprising a next particular operation, a next particular user interface, and a next particular data slice to be used by the particular user as the particular user navigates the particular user interface;
for a particular action tuple of the particular set of particular action tuples, determining a particular user interface navigation target for the next particular operation, the next particular user interface, and the next particular data slice, wherein the particular user interface navigation target causes user interface navigation based on the next particular operation, the next particular user interface, or the next particular data slice, or a combination thereof; and
causing display of a particular summary of the particular action tuple and an option to perform the particular user interface navigation to the particular user interface navigation target.

2. The computer-implemented method of claim 1, further comprising:
for a selected particular action tuple, executing the option by causing the particular user interface navigation to the particular user interface target.

3. The computer-implemented method of claim 2, further comprising:
causing display of the option as a selectable link in the particular user interface, wherein the executing the option is in response to user input selecting the selectable link.

4. The computer-implemented method of claim 1, further comprising:
storing data collected during one or more user sessions of the particular user, the stored data indicating previously selected and executed options corresponding to previously predicted particular action tuples associated with the particular user;
training a machine learning model to select a set of most likely action tuples from the particular set of particular action tuples based at least in part on the stored data; and
using the trained machine learning model to select a subset of the particular set of particular action tuples as the set of most likely action tuples,
wherein the determining the particular user interface navigation target, the causing display of the particular summary, and the causing display of the option is for each most likely action tuple of the set of most likely action tuples.

5. The computer-implemented method of claim 1, further comprising:
selecting, as a set of most likely action tuples, a subset of the particular set of particular action tuples,
wherein the determining the particular user interface navigation target, the causing display of the particular summary, and the causing display of the option is for each most likely action tuple of the set of most likely action tuples.

6. The computer-implemented method of claim 5, wherein the selecting the set of most likely action tuples is based at least in part on respective likelihoods of each particular action tuple of the particular set of particular action tuples, the respective likelihoods being predicted using the multi-layer neural network.

7. The computer-implemented method of claim 5, wherein the selecting the set of most likely action tuples from the particular set of particular action tuples is based at least in part on previously selected and executed options corresponding to previously predicted particular action tuples associated with the particular user.

8. The computer-implemented method of claim 5, wherein the selecting the set of most likely action tuples comprises selecting a threshold quantity of action tuples from the particular set of particular action tuples as the set of most likely action tuples.

9. The computer-implemented method of claim 8, further comprising:
storing data collected during one or more user sessions of the particular user, the stored data indicating previously selected and executed options corresponding to previously predicted particular action tuples associated with the particular user;
training a machine learning model to determine the threshold quantity of action tuples based at least in part on the stored data; and
using the trained machine learning model to adjust the threshold quantity of action tuples that is to be selected from the particular set of particular action tuples as the set of most likely action tuples.

10. A computer-program product comprising one or more non-transitory machine-readable storage media, including stored instructions configured to cause a computing system to perform a set of actions comprising:
training a multi-layer neural network to detect a set of learned action tuples each comprising a next user interface, a next operation, and a next data slice, wherein the multi-layer neural network is trained at least in part by randomly selecting adjacent groups of user inputs to predict a sequentially next user input, and wherein the multi-layer neural network is also trained at least in part by randomly selecting adjacent groups of user inputs to predict a sequentially previous user input, wherein the multi-layer neural network is trained on one or more vector embeddings comprising a data slice in use, an interface in use, and an operation being performed at adjacent times;
receiving particular input from a particular user as the particular user navigates to a particular user interface to perform one or more tasks against multidimensional data;
detecting that the particular input causes a particular operation to be performed on the particular user interface with respect to a particular data slice;
storing a particular data structure that identifies the particular operation, the particular user interface, and the particular data slice;
providing the particular data structure as input to the multi-layer neural network to predict a particular set of particular action tuples, each comprising a next particular operation, a next particular user interface, and a next particular data slice to be used by the particular user as the particular user navigates the particular user interface;
for a particular action tuple of the particular set of particular action tuples, determining a particular user interface navigation target for the next particular operation, the next particular user interface, and the next particular data slice, wherein the particular user interface navigation target causes user interface navigation based on the next particular operation, the next particular user interface, or the next particular data slice, or a combination thereof; and
causing display of a particular summary of the particular action tuple and an option to perform the particular user interface navigation to the particular user interface navigation target.

11. The computer-program product of claim 10, wherein the set of actions further comprise:
selecting, as a set of most likely action tuples, a subset of the particular set of particular action tuples,
wherein the determining the particular user interface navigation target, the causing display of the particular summary, and the causing display of the option is for each most likely action tuple of the set of most likely action tuples.

12. The computer-program product of claim 11, wherein the selecting the set of most likely action tuples is based at least in part on respective likelihoods of each particular action tuple of the particular set of particular action tuples, the respective likelihoods being predicted using the multi-layer neural network.

13. The computer-program product of claim 11, wherein the selecting the set of most likely action tuples from the particular set of particular action tuples is based at least in part on previously selected and executed options corresponding to previously predicted particular action tuples associated with the particular user.

14. The computer-program product of claim 11, wherein the selecting the set of most likely action tuples comprises selecting a threshold quantity of action tuples from the particular set of particular action tuples as the set of most likely action tuples.

15. The computer-program product of claim 14, further comprising:
storing data collected during one or more user sessions of the particular user, the stored data indicating previously selected and executed options associated with previously predicted particular action tuples for the particular user;
training a machine learning model to determine the threshold quantity of action tuples based at least in part on the stored data; and
using the trained machine learning model to adjust the threshold quantity of action tuples that is to be selected from the particular set of particular action tuples as the set of most likely action tuples.

16. A system comprising:
one or more processors;
one or more non-transitory computer-readable media storing instructions, which, when executed by the system, cause the system to perform a set of actions comprising:
training a multi-layer neural network to detect a set of learned action tuples each comprising a next user interface, a next operation, and a next data slice, wherein the multi-layer neural network is trained at least in part by randomly selecting adjacent groups of user inputs to predict a sequentially next user input, and wherein the multi-layer neural network is also trained at least in part by randomly selecting adjacent groups of user inputs to predict a sequentially previous user input, wherein the multi-layer neural network is trained on one or more vector embeddings comprising a data slice in use, an interface in use, and an operation being performed at adjacent times;
receiving particular input from a particular user as the particular user navigates to a particular user interface to perform one or more tasks against multidimensional data;
detecting that the particular input causes a particular operation to be performed on the particular user interface with respect to a particular data slice;
storing a particular data structure that identifies the particular operation, the particular user interface, and the particular data slice;
providing the particular data structure as input to the multi-layer neural network to predict a particular set of particular action tuples, each comprising a next particular operation, a next particular user interface, and a next particular data slice to be used by the particular user as the particular user navigates the particular user interface;
for a particular action tuple of the particular set of particular action tuples, determining a particular user interface navigation target for the next particular operation, the next particular user interface, and the next particular data slice, wherein the particular user interface navigation target causes user interface navigation based on the next particular operation, the next particular user interface, or the next particular data slice, or a combination thereof; and
causing display of a particular summary of the particular action tuple and an option to perform the particular user interface navigation to the particular user interface navigation target.

17. The system of claim 16, wherein the set of actions further comprise:
for a selected particular action tuple, executing the option by causing the particular user interface navigation to the particular user interface target.

18. The system of claim 17, wherein the set of actions further comprise:
causing display of the option as a selectable link in the particular user interface, wherein the executing the option is in response to user input selecting the selectable link.

19. The system of claim 16, wherein the set of actions further comprise:
storing data collected during one or more user sessions of the particular user, the stored data indicating previously selected and executed options corresponding to previously predicted particular action tuples associated with the particular user;
training a machine learning model to select a set of most likely action tuples from the particular set of particular action tuples based at least in part on the stored data; and
using the trained machine learning model to select a subset of the particular set of particular action tuples as the set of most likely action tuples,
wherein the determining the particular user interface navigation target, the causing display of the particular summary, and the causing display of the option is for each most likely action tuple of the set of most likely action tuples.

20. The system of claim 16, wherein the set of actions further comprise:
selecting, as a set of most likely action tuples, a subset of the particular set of particular action tuples,
wherein the determining the particular user interface navigation target, the causing display of the particular summary, and the causing display of the option is for each most likely action tuple of the set of most likely action tuples.
